(19) United States
(12) Patent Application Publication
(10) Pub. No.: US 2024/0409084 A1
(43) Pub. Date: Dec. 12, 2024

(54) JACKKNIFING SUPPRESSION DEVICE, JACKKNIFING SUPPRESSION METHOD, AND NON-TRANSITORY COMPUTER-READABLE MEDIUM

(71) Applicants: JTEKT CORPORATION, Kariya-shi, Aichi-ken (JP); J-QuAD DYNAMICS INC., Tokyo (JP)

(72) Inventors: Hirotaka TOKORO, Tokyo (JP); Nobuhiro NITTA, Tokyo (JP)

(73) Assignees: JTEKT CORPORATION, Kariya-shi, Aichi-ken (JP); J-QuAD DYNAMICS INC., Tokyo (JP)

(21) Appl. No.: 18/726,005

(22) PCT Filed: Dec. 26, 2022
(86) PCT No.: PCT/JP2022/047923

§ 371 Date: Jul. 1, 2024

(30) Foreign Application Priority Data
Jan. 7, 2022 (JP) 2022-001525

(51) Int. Cl. B60W 30/02; B60W 40/12; B60W 50/00

(52) U.S. Cl. CPC B60W 30/02; B60W 40/12; B60W 50/0097; B60W 2300/145; B60W 2510/20; B60W 2520/10; B60W 2520/22; B60W 2720/10; B60W 2720/22

(57) ABSTRACT

A jackknife suppression device is configured to execute an acquisition process, a prediction process, a determination process, and a treatment process. The acquisition process is a process of acquiring a hitch angle variable and a steered angle variable. The prediction process is a process of calculating a predicted value of the hitch angle using the hitch angle variable and the steered angle variable as inputs. The determination process is a process of determining whether there is a high risk that a jackknife occurs using the predicted value and the steered angle variable as inputs. The treatment process is a process of operating predetermined hardware in order to suppress occurrence of the jackknife when it is determined that the risk is high.

### TECHNICAL FIELD

The present disclosure relates to a jackknife suppression device, a jackknife suppression method, and a jackknife suppression program.

### BACKGROUND ART

Patent Document 1 below, for example, describes a device that detects a jackknife state when a hitch angle exceeds a maximum steering angle.

### RELATED ART DOCUMENTS

### Patent Documents

Patent Document 1: US Patent Application Publication No. 2020/001920

### SUMMARY OF THE INVENTION

### Problem to be Solved by the Invention

The above device is a device that identifies whether the present state is a jackknife state. Therefore, it is not possible to take measures to avoid falling into a jackknife state before falling into a jackknife state.

### Means for Solving the Problem

An aspect of the present disclosure provides a jackknife suppression device. The jackknife suppression device is applicable to a combined vehicle including a tractor and a trailer to be towed by the tractor, and is configured to execute an acquisition process, a prediction process, a determination process, and a treatment process; the acquisition process is a process of acquiring a hitch angle variable and a steered angle variable, the hitch angle variable being a variable that indicates a hitch angle that is an angle between a front-rear direction of the tractor and a front-rear direction of the trailer, and the steered angle variable being a variable that indicates a steered angle of the tractor; the prediction process is a process of calculating a predicted value of the hitch angle using the hitch angle variable and the steered angle variable as inputs; the determination process is a process of determining whether there is a high risk that a jackknife occurs using the predicted value and the steered angle variable as inputs; and the treatment process is a process of operating predetermined hardware in order to suppress occurrence of the jackknife when it is determined that the risk is high.

Another aspect of the present disclosure provides a jackknife suppression method. The jackknife suppression method is applicable to a combined vehicle including a tractor and a trailer to be towed by the tractor, and executes an acquisition process, a prediction process, a determination process, and a treatment process; the acquisition process is a process of acquiring a hitch angle variable and a steered angle variable, the hitch angle variable being a variable that indicates a hitch angle that is an angle between a front-rear direction of the tractor and a front-rear direction of the trailer, and the steered angle variable being a variable that indicates a steered angle of the tractor; the prediction process is a process of calculating a predicted value of the hitch angle using the hitch angle variable and the steered angle variable as inputs; the determination process is a process of determining whether there is a high risk that a jackknife occurs using the predicted value and the steered angle variable as inputs; and the treatment process is a process of operating predetermined hardware in order to suppress occurrence of the jackknife when it is determined that the risk is high.

Another aspect of the present disclosure provides a jackknife suppression program that is applicable to a combined vehicle including a tractor and a trailer to be towed by the tractor. The jackknife suppression program is a program that causes a computer to execute an acquisition process, a prediction process, a determination process, and a treatment process; the acquisition process is a process of acquiring a hitch angle variable and a steered angle variable, the hitch angle variable being a variable that indicates a hitch angle that is an angle between a front-rear direction of the tractor and a front-rear direction of the trailer, and the steered angle variable being a variable that indicates a steered angle of the tractor; the prediction process is a process of calculating a predicted value of the hitch angle using the hitch angle variable and the steered angle variable as inputs; the determination process is a process of determining whether there is a high risk that a jackknife occurs using the predicted value and the steered angle variable as inputs; and the treatment process is a process of operating predetermined hardware in order to suppress occurrence of the jackknife when it is determined that the risk is high.

### BRIEF DESCRIPTION OF THE DRAWINGS

FIG. 1 is a perspective view illustrating the configuration of a combined vehicle according to a first embodiment.

FIG. 2 is a block diagram illustrating the configuration of a control system according to the embodiment.

FIG. 3 is a flowchart illustrating the procedure of a process executed by a control device according to the embodiment.

FIG. 4 illustrates a model of the combined vehicle according to the embodiment.

FIG. 5 illustrates the magnitude of a risk according to the embodiment.

FIGS. 6A and 6B illustrate the effects of the embodiment.

FIG. 7 is a flowchart illustrating the procedure of a process executed by a control device according to a second embodiment.

FIG. 8 is a flowchart illustrating the procedure of a process executed by a control device according to a third embodiment.

FIG. 9 is a flowchart illustrating the procedure of a process executed by a control device according to a fourth embodiment.

### MODES FOR CARRYING OUT THE INVENTION

### First Embodiment

A first embodiment will be described below with reference to the drawings.

### “Configuration of Combined Vehicle”

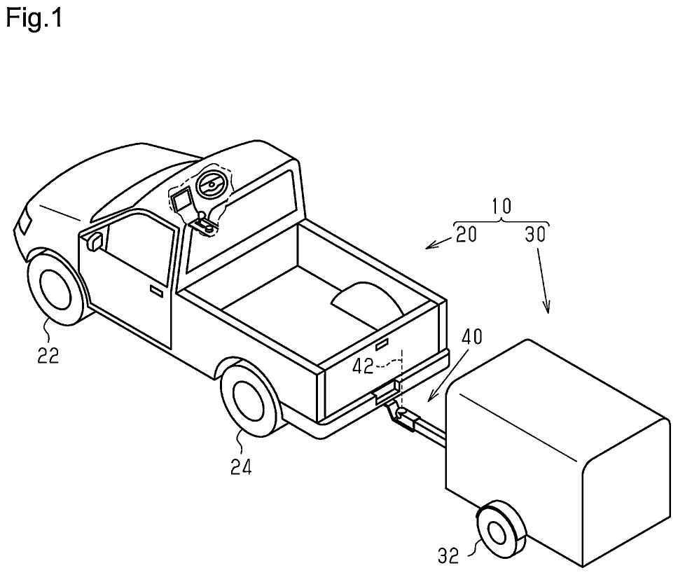

As illustrated in FIG. 1, a combined vehicle 10 includes a tractor 20 and a trailer 30. FIG. 1 illustrates a pickup truck as a type of small freight vehicle as the tractor 20. The tractor 20 includes front wheels 22 and rear wheels 24. The front wheels 22 include two wheels, namely a right front wheel and a left front wheel, and the rear wheels 24 include two wheels, namely a right rear wheel and a left rear wheel. FIG. 1 illustrates a box-shaped trailer as the trailer 30. The trailer 30 includes wheels 32. The wheels 32 include two wheels, namely a right wheel and a left wheel.

The trailer 30 is coupled to a rear portion of the tractor 20 via a ball joint 40. The ball joint 40 is a member that couples the trailer 30 to the tractor 20 so as to be rotatable about an axis 42. The axis 42 extends along the height direction of the tractor 20.

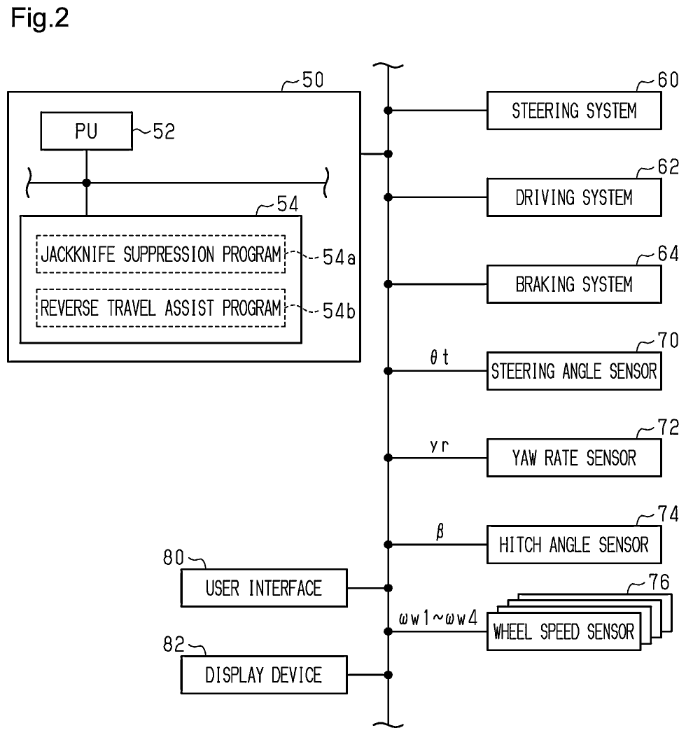

FIG. 2 illustrates some of the members of the tractor 20. As illustrated in FIG. 2, the tractor 20 includes a control device 50. The control device 50 operates a steering system 60, a driving system 62, and a braking system 64 in order to control the control amount of the combined vehicle 10 as a control target. The control amount includes a vehicle speed, a travel direction, a hitch angle, etc. The hitch angle is an angle between the front-rear direction of the tractor 20 and the front-rear direction of the trailer 30.

The steering system 60 includes a steering actuator that steers steered wheels. Examples of the steered wheels include the front wheels 22 illustrated in FIG. 1. The steering system 60 may include a steering control device that operates a steering actuator. In that case, the language “the control device 50 operates the steering system 60” means that the control device 50 outputs a command signal to the steering control device.

The driving system 62 includes at least one of two devices, that is, an internal combustion engine and a rotary electric machine, as a thrust generation device for the vehicle. The driving system 62 may include a drive control device that controls an internal combustion engine and a rotary electric machine. In that case, the language “the control device 50 operates the driving system 62” means that the control device 50 outputs a command signal to the drive control device.

The braking system 64 includes at least one of two devices, that is, a device that decelerates the rotation of the wheels using a frictional force and a device that decelerates the rotation of the wheels by converting the power of the wheels into electrical energy. The device that decelerates the rotation of the wheels by converting the power of the wheels into electrical energy may be shared with the rotary electric machine of the driving system. The braking system 64 may include a braking control device that controls a device that decelerates the rotation of the wheels. In that case, the language “the control device 50 operates the braking system 62” means that the control device 50 outputs a command signal to the braking control device.

The control device 50 references a steered angle θt of the steered wheels detected by a steering angle sensor 70 and a yaw rate yr detected by a yaw rate sensor 72, in order to control the control amount. The steered angle θt is a value having a positive sign for one of the right turn and the left turn and having a negative sign for the other. The steered angle θt is the turning angle of the tires. When the steering system 60 includes a rack and pinion mechanism, for example, the steering angle sensor 70 may be a sensor that detects the pinion angle. In that case, however, the control device 50 executes a process of converting the pinion angle into the turning angle of the tires. In the following, for convenience of description, the turning angle of the tires is regarded as a detected value from the steering angle sensor 70, even if the turning angle is obtained by the above conversion process.

The control device 50 references a hitch angle β detected by the hitch angle sensor 74 and wheel speeds ωw1 to ωw4 detected by wheel speed sensors 76. The hitch angle β may have either a positive sign or a negative sign according to the angle between the direction from the rear toward the front of the tractor 20 and the direction from the rear toward the front of the trailer 30. For example, the hitch angle β may have a positive sign when the direction from the rear toward the front of the trailer 30 deviates counterclockwise with respect to the direction from the rear toward the front of the tractor 20 by less than 180 degrees. The wheel speeds ωw1 and ωw2 are the rotational speed of the right front wheel 22 and the rotational speed of the left front wheel 22, respectively. The wheel speeds ωw3 and ωw4 are the rotational speed of the right rear wheel 24 and the rotational speed of the left rear wheel 24, respectively. The control device 50 sets control of the control amount according to the operating state of a user interface 80. The user interface 80 is used to transmit the intention of a user to the control device 50, such as an intention to select one of autonomous driving and manual driving.

The control device 50 includes a PU 52 and a storage device 54. The PU 52 is a software processing device that includes at least one of a CPU, a GPU, a TPU, etc. The storage device 54 stores a jackknife suppression program 54a and a reverse travel assist program 54b.

The jackknife suppression program 54a is a program that prescribes a command to cause the PU 52 to execute a process of suppressing a jackknife. The reverse travel assist program 54b is a program that prescribes a command to cause the PU 52 to execute reverse travel control through autonomous driving of the combined vehicle 10. In other words, the reverse travel assist program 54b is a program that prescribes a command to cause the PU 52 to execute an automatic steering process.

### “Process of Suppressing Jackknife”

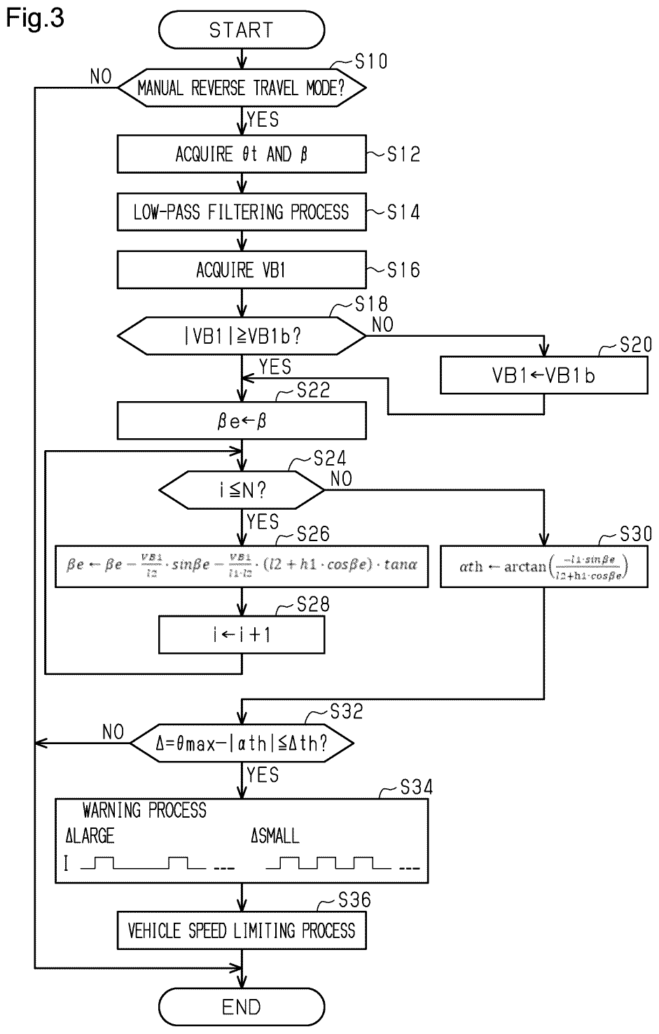

FIG. 3 illustrates the procedure of a process of suppressing a jackknife. The process illustrated in FIG. 3 is implemented by the PU 52 executing the jackknife suppression program 54a repeatedly in predetermined cycles, for example. In the following, the step number of each process is expressed by a number preceded by “S”.

In the series of processes illustrated in FIG. 3, the PU 52 first determines whether the vehicle is in a manual reverse travel mode (S10). In other words, it is determined whether the vehicle is in a mode in which the user drives the combined vehicle 10 in reverse without executing the reverse travel assist program 54b.

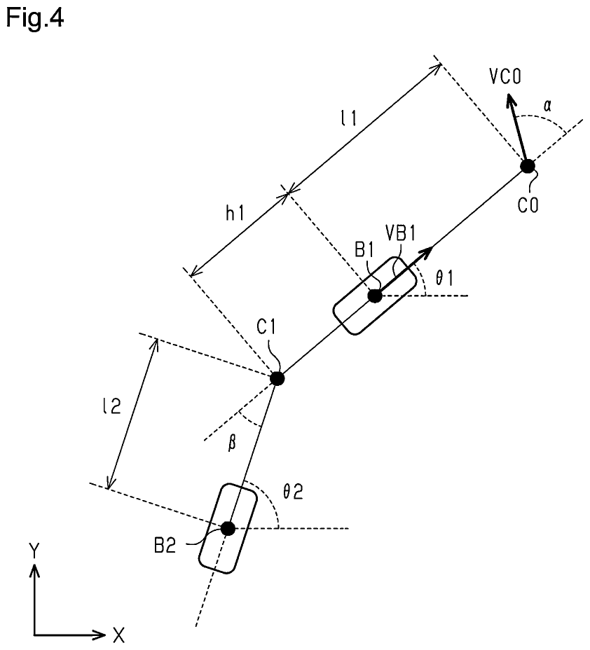

When it is determined that the vehicle is in the manual reverse travel mode (S10: YES), the PU 52 acquires a steered angle θt and a hitch angle β (S12). This process corresponds to an acquisition process of acquiring a hitch angle variable and a steered angle variable. Then, the PU 52 performs a low-pass filtering process on the steered angle θt and the hitch angle β to remove high-frequency components (S14). Next, the PU 52 acquires a rear wheel vehicle speed VB1 of the combined vehicle 10 (S16). Here, the rear wheel vehicle speed VB1 is the vehicle speed at rear wheels B1 in a model illustrated in FIG. 4 to be discussed later. The rear wheel vehicle speed VB1 has a positive sign when the tractor 20 travels forward, and has a negative sign when the tractor 20 travels in reverse. The rear wheel vehicle speed VB1 is calculated by the PU 52 based on at least one of the wheel speeds ωw1 to ωw4. The rear wheel vehicle speed VB1 may be a value obtained by converting the average value of the wheel speeds ωw3 and ωw4 into a translational speed, for example. This process corresponds to an acquisition process of acquiring a vehicle speed.

Next, the PU 52 determines whether the absolute value of the rear wheel vehicle speed VB1 is equal to or more than a reference value VB1b (S18). When it is determined that the above absolute value is not equal to or more than the reference value VB1b (S18: NO), the PU 52 substitutes the reference value VB1b into the rear wheel vehicle speed VB1 as a variable to be used in a prediction process to be discussed later (S20). The PU 52 substitutes the hitch angle β acquired in the process in S12 into a predicted hitch angle βe (S22) when completing the process in S20 and when making an affirmative determination in the process in S18. This process is a process of determining an initial value in a process of predicting a hitch angle β to be discussed later.

Next, the PU 52 determines whether a variable i is equal to or less than a prescribed number N (S24). The variable i is a variable for counting the number of times of execution of the process in S26 to be discussed later. The variable i has an initial value of zero. On the other hand, the prescribed number N is a natural number that is equal to or more than “1”. When it is determined that the variable i is equal to or less than the prescribed number N (S24: YES), the PU 52 calculates a predicted hitch angle βe for the future a unit time ahead (S26). This will be described below.

FIG. 4 illustrates a model to be used to predict a hitch angle β. In the model illustrated in FIG. 4, a pair of front wheels 22 of the tractor 20 is indicated as front wheels C0, and a pair of rear wheels 24 of the tractor 20 is indicated as rear wheels B1. That is, a two-wheel model is adopted for the tractor 20. Further, a pair of wheels 32 of the trailer 30 is indicated as wheels B2. The angle between a line defined by the front wheels C0 and a hitch point C1 and a line defined by the hitch point C1 and the wheels B2 is the hitch angle β. The hitch point C1 corresponds to the axis 42 portion in FIG. 1. Further, a front wheel speed VC0 as the speed of the front wheels C0 is a vector that moves in the direction of the steered angle α. The hitch angle β is modeled as the angle between the direction in which the front wheels C0 travel and the line defined by the front wheels C0 and the hitch point C1. The direction of the rear wheel vehicle speed VB1 is parallel to the line defined by the front wheels C0 and the hitch point C1. Further, the angle between the direction of the rear wheel vehicle speed VB1 and the x direction in FIG. 4 is an angle θ1. Further, the angle between the line connecting the wheels B2 and the hitch point C1 and the x direction is an angle θ2. Further, a distance 11 between the front wheels C0 and the rear wheels B1, a distance h1 between the rear wheels B1 and the hitch point C1, and a distance 12 between the hitch point C1 and the wheels B2 are defined.

In the model illustrated in FIG. 4, a time derivative dβ/dt of the hitch angle β is expressed by the following equation (c1).

$$d β / dt = - ( VB 1 / l 2 ) \cdot sin β - \{ VB 1 / ( l 1 \cdot l 2 ) \} \cdot ( l 2 + h 1 \cdot cos β ) \cdot tan α \qquad ( c 1 )$$

The following update formula for the predicted hitch angle βe is obtained by expressing the time derivative dβ/dt as a differential per unit time in the above equation. The PU 52 calculates a predicted hitch angle βe using the following update formula in the process in S26.

$$β e ← β e - ( VB 1 / l 2 ) \cdot sin β e - \{ VB 1 / ( l 1 \cdot l 2 ) \} \cdot ( l 2 + h 1 \cdot cos β e ) \cdot tan α$$

Returning to FIG. 3, when the process in S26 is executed, the PU 52 increases the variable i by “1” (S28). Then, the PU 52 returns to the process in S24. The processes in S18 to S28 correspond to a prediction process.

When it is determined that the variable i is not equal to or less than the prescribed number N (S24: NO), on the other hand, the PU 52 calculates a threshold value αth that is the minimum steered angle at which a jackknife occurs (S30). Specifically, the PU 52 substitutes “arctan{−11·sin βe/(12+h1·cos βe)}” into the threshold value αth. This is a process in which the threshold value αth is set to the steered angle at the time when the time derivative dβ/dt in the above equation (c1) is set to zero. That is, when a jackknife occurs, the hitch angle β increases, irrespective of whether the vehicle is steered to turn right or left. Therefore, the steered angle α having a lower limit magnitude at which a jackknife occurs is the steered angle at the time when the time derivative dβ/dt is set to zero in the above equation (c1).

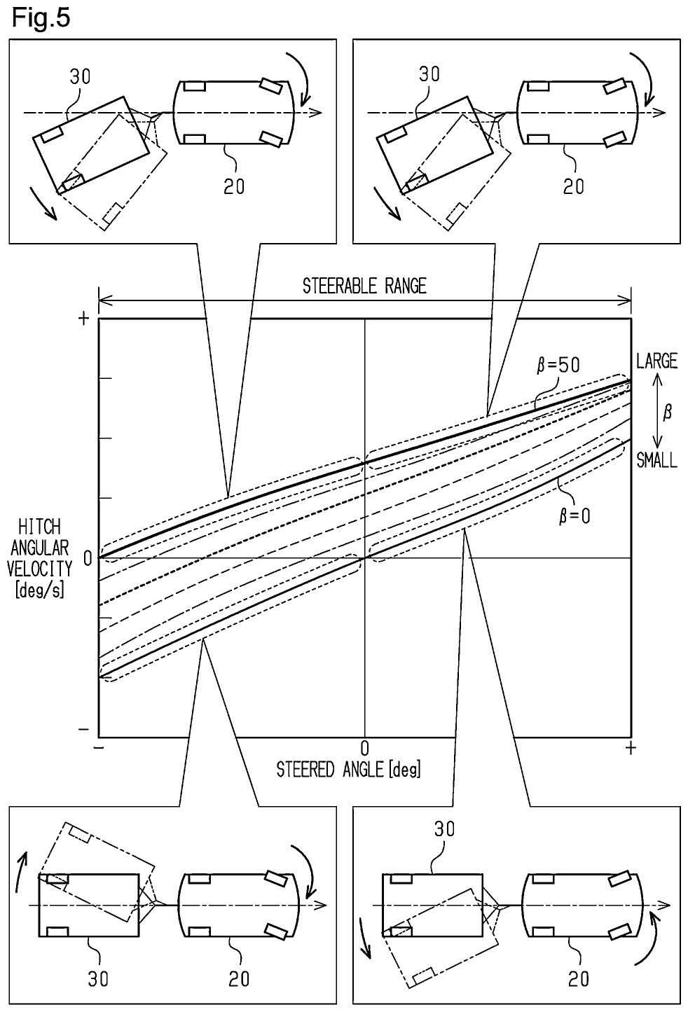

As illustrated in FIG. 5, when the hitch angle β is “0°”, the trailer 30 turns right when the steered angle θt has a value on the right turn side, while the trailer 30 turns left when the steered angle θt has a value on the left turn side. When the hitch angle β is “50°”, on the other hand, the trailer 30 turns left, irrespective of whether the steered angle θt has a value on the right turn side or a value on the left turn side. That is, control for reducing the magnitude of the hitch angle β cannot be performed by operating the steered angle θt.

Returning to FIG. 3, the PU 52 determines whether an amount Δ by which a maximum steered angle θtmax exceeds the absolute value of the threshold value αth is equal to or less than a prescribed value Δth (S32). The maximum steered angle θtmax is the maximum value of the magnitude of the steered angle θt. Here, the prescribed value Δth is set to a lower limit value at which it is determined that there is a possibility that a jackknife may occur. The processes in S30 and S32 correspond to a determination process. Further, the process in S30 corresponds to a threshold setting process. The process in S32 corresponds to a risk determination process.

In FIG. 5, it is indicated that when the hitch angle β is “50°”, the hitch angular velocity as the speed of the hitch angle β is equal to or more than zero. Therefore, the magnitude of the steered angle θt at which the hitch angular velocity becomes zero matches the maximum steered angle θtmax. Thus, when the hitch angle β is “50°”, it is no longer possible to avoid a jackknife. On the contrary, when the hitch angle β is “0°”, for example, the steered angle at which the hitch angular velocity becomes zero is “0°”. Therefore, there is a large difference between the absolute value of the threshold value αth and the maximum steered angle θtmax. Thus, there is an allowance before a jackknife occurs. Thus, there is a higher risk that a jackknife occurs as the amount Δ by which the maximum steered angle θtmax exceeds the absolute value of the threshold value αth is smaller. Thus, the amount Δ is a variable that indicates the degree of a risk that a jackknife occurs.

Returning to FIG. 3, when it is determined that the amount Δ is equal to or less than the prescribed value Δth (S32: YES), the PU 52 executes a warning process by operating a display device 82 (S34). Specifically, the PU 52 causes an image of a predetermined object displayed on the display device 82 to blink on and off. Here, the PU 52 changes the cycle of blinking on and off the image according to the magnitude of the amount 4. Specifically, the PU 52 makes the cycle for a greater amount Δ equal to or longer than the cycle for a smaller amount Δ. This process can be implemented by the PU 52 performing a map calculation of the cycle based on the amount Δ with map data stored in the storage device 54, for example. Here, the map data are data that uses the amount & as an input variable and the cycle as an output variable. The map data are a set of data that include discrete values of the input variable and values of the output variable corresponding to the values of the input variable. Further, the map calculation may be a process in which when the value of the input variable matches any of the values of the input variable of the map data, the corresponding value of the output variable of the map data is used as the calculation result. In addition, the map calculation may be a process in which when the value of the input variable does not match any of the values of input variable of the map data, a value obtained by interpolating a plurality of values of the output variable included in the map data is used as the calculation result. Alternatively, the map calculation may be a process in which when the value of the input variable does not match any of the values of input variable of the map data, a value of the output variable of the map data corresponding to the closest value among a plurality of values of the output variable included in the map data is used as the calculation result. The process in S34 corresponds to an informing process.

Further, the PU 52 limits the vehicle speed of the combined vehicle 10 to a lower side by operating the driving system 62 and the braking system 64 (S36). That is, the PU 52 limits the driving force generated by the driving system 62, or applies a braking force, so that the combined vehicle 10 does not exceed an upper limit speed determined in advance according to an accelerator operation etc. by the user. The process in S36 corresponds to a treatment process.

The PU 52 temporarily ends the series of processes illustrated in FIG. 3 when completing the process in S36 and when making a negative determination in the process in S10. Here, the functions and the effects of the present embodiment will be described.

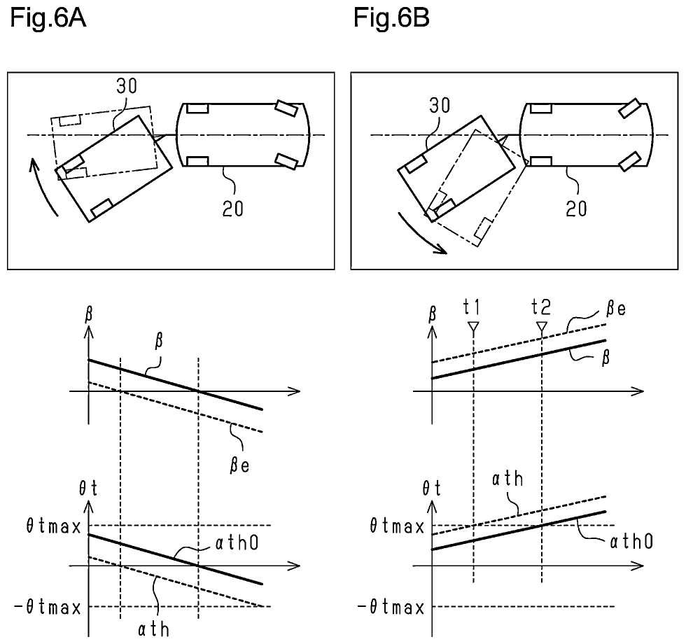

FIGS. 6A and 6B illustrate the displacement of the hitch angle β. Specifically, FIG. 6A illustrates a state in which the steered angle θt is turned to the right turn side and the hitch angle β is displaced in a direction in which the magnitude of the hitch angle β becomes smaller. In that case, there is a low risk that a jackknife occurs.

On the contrary, FIG. 6B illustrates a state in which the steered angle θt is turned to the left turn side and the hitch angle β is displaced in a direction in which the magnitude of the hitch angle β becomes larger. In that case, there is a high risk that a jackknife occurs. Therefore, the PU 52 informs the user that there is a high possibility that a jackknife will occur.

Specifically, when the amount Δ by which the maximum steered angle θtmax exceeds the absolute value of the threshold value αth is small, the PU 52 determines that there is a high possibility that a jackknife will occur. Here, the threshold value αth is calculated according to the predicted hitch angle βe. On the contrary, FIGS. 6A and 6B also indicate a threshold value αth0 calculated using the present hitch angle β. As illustrated in FIG. 6B, a time t1 when the threshold value αth reaches the maximum steered angle θtmax is earlier than a time t2 when the threshold value αth0 reaches the maximum steered angle θtmax. Therefore, according to the present embodiment, it is possible to detect the risk that a jackknife occurs and issue a warning early.

According to the present embodiment described above, the following functions and effects can be further obtained.
(1-1) The PU 52 executes a process of calculating a predicted hitch angle βe for the future a unit time ahead using the hitch angle β as an input, and thereafter executes a process of calculating a predicted hitch angle βe for the future a unit time further ahead using the predicted hitch angle βe as an input at least once. Then, the PU 52 calculates a threshold value αth using the finally calculated predicted hitch angle βe. Consequently, it is possible to enhance the precision of the predicted hitch angle βe to be used to calculate the threshold value αth better than that obtained through linear approximation.
(1-2) When the rear wheel vehicle speed VB1 is zero, the hitch angle β does not change according to the above equation (c1). Therefore, when the rear wheel vehicle speed VB1 is excessively low, there is a possibility that the change in the predicted hitch angle βe may become excessively small. Therefore, when the combined vehicle 10 starts from a stationary state, for example, it is difficult to predict whether a jackknife will occur immediately thereafter. Thus, when the rear wheel vehicle speed VB1 is less than the reference value VB1b, the PU 52 substitutes the reference value VB1b into the rear wheel vehicle speed VB1, to be input to the process of calculating the predicted hitch angle βe. Consequently, it is possible to predict whether a jackknife will occur when the combined vehicle 10 accelerates from an extremely low speed.
(1-3) When the amount by which the maximum steered angle θtmax exceeds the steered angle θt at which a jackknife occurs is large, the hitch angle β can be changed both to the right and to the left by changing the steered angle θt. This allows avoiding a jackknife. When the amount by which the maximum steered angle θtmax exceeds the steered angle θt at which a jackknife occurs becomes zero, on the other hand, the direction in which the steered angle θt is changed is limited. This also limits the direction of change in the hitch angle. Therefore, there is a possibility that the steered angle may not be operated so as to avoid a jackknife. Thus, the PU 52 determines that there is a high risk when the amount by which the maximum steered angle θtmax exceeds the absolute value of the threshold value αth is equal to or less than the predetermined value Δth. This makes it possible to determine whether there is a high risk that a jackknife occurs.
(1-4) When there is a high risk that a jackknife occurs, the PU 52 makes an indication of such a risk. This allows the user to recognize that there is a high risk that a jackknife occurs. Therefore, the user can be prompted to drive so as not to cause a jackknife.

### Second Embodiment

A second embodiment will be described below with reference to the drawings, focusing on the differences from the first embodiment.

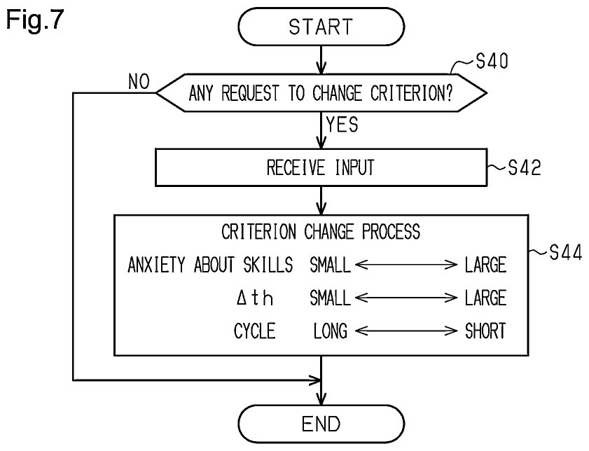

In the first embodiment described above, the criterion for the magnitude of the possibility that a jackknife will occur is set in advance. In the present embodiment, on the contrary, the user is allowed to change the criterion. FIG. 7 illustrates the procedure of a process of changing the criterion. The process illustrated in FIG. 7 is implemented by the PU 52 executing the jackknife suppression program 54a repeatedly in predetermined cycles, for example.

In the series of processes illustrated in FIG. 7, the PU 52 first determines whether there is an input operation that indicates an intention to change the criterion on the user interface 80 (S40). When it is determined that there is an input operation (S40: YES), the PU 52 receives the input for changing the criterion (S42). This process may be performed as follows. First, the PU 52 displays on the display device 82 several options about how to change the criterion. Specifically, the PU 52 presents an option to determine earlier to be in danger and an option less likely to determine to be in danger than the criterion given by default, according to the feeling of the user about his/her own driving skills, for example. Here, a plurality of options to determine earlier to be in danger may be provided, for example. Further, a plurality of options less likely to determine to be in danger may be provided, for example. The process in S42 corresponds to a reception process.

Then, the PU 52 changes the criterion according to the option (S44). Here, the PU 52 sets the prescribed value Δth according to the anxiety about the driving skills. Here, the prescribed value Δth at the time when the anxiety about the driving skills is high is set to be equal to or more than the prescribed value Δth at the time when the anxiety about the driving skills is low. When the amount Δ is equal to or less than the prescribed value Δth, the PU 52 sets the blinking cycle according to the anxiety about the driving skills, even if the amount Δ is the same. Here, the cycle at the time when the anxiety about the driving skills is high is set to be equal to or less than the cycle at the time when the anxiety about the driving skills is low. The process in S44 corresponds to a setting process.

The PU 52 temporarily ends the series of processes illustrated in FIG. 7 when completing the process in S44 and when making a negative determination in the process in S40. According to the present embodiment described above, the following functions and effects can be obtained.
(2-1) When the criterion for determining that there is a high risk that a jackknife occurs is set to be strict, driving may be restricted even in a situation in which it is possible to travel without causing a jackknife, depending on the driving skills. When the criterion is set to be lenient, on the other hand, there is a possibility that a jackknife may occur due to a delay in determining that there is a high risk when a user that does not have high driving skills drives. Thus, the PU 52 receives the intention of the user about the criterion. This allows the user to set the criterion according to his/her own driving skills.
(2-2) The PU 52 sets the blinking cycle according to the magnitude of the anxiety about the driving skills, even if the amount Δ is the same. Consequently, the blinking cycle can be appropriately reduced as the amount Δ becomes smaller than the prescribed value Δth, using the prescribed value Δth as a criterion for indicating that there is a high risk.

### Third Embodiment

A third embodiment will be described below with reference to the drawings, focusing on the differences from the first embodiment.

In the first embodiment, the risk that a jackknife occurs is quantified according to the amount Δ by which the maximum steered angle θtmax exceeds the absolute value of the threshold value αth. In the present embodiment, on the contrary, the risk is quantified according to the time required for the absolute value of the threshold value αth, as the steered angle θt at which it is determined that a jackknife occurs, to reach the maximum steered angle θtmax.

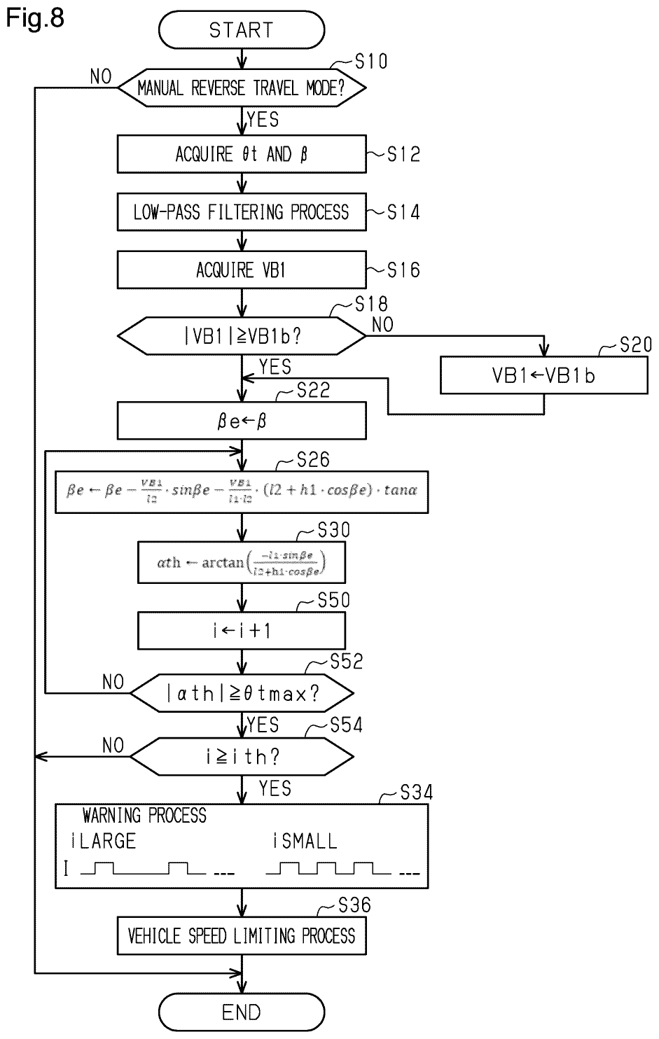

FIG. 8 illustrates the procedure of a process of suppressing a jackknife according to the present embodiment. The process illustrated in FIG. 8 is implemented by the PU 52 executing the jackknife suppression program 54a repeatedly in predetermined cycles, for example. In FIG. 8, the same step numbers are given to processes corresponding to the processes illustrated in FIG. 3 for convenience, and the description thereof will be omitted.

In the series of processes illustrated in FIG. 8, when completing the process in S22, the PU 52 sequentially executes the processes in S26 and S30. Then, the PU 52 increases a variable i that indicates the number of times the processes in S26 and S30 are executed by “1” (S50). The variable i has an initial value of “0”. Then, the PU 52 determines whether the absolute value of the threshold αth is equal to or more than the maximum steered angle θtmax (S52). When it is determined that the absolute value is not equal to or more than the maximum steered angle θtmax (S52: NO), the PU 52 returns to the process in S26. The processes in S18 to S22, S26, S30, S50, and S52 correspond to a prediction process.

When it is determined that the maximum steered angle θtmax is equal to or more than the maximum steered angle θtmax (S52: YES), on the other hand, the PU 52 determines whether the variable i is equal to or more than a threshold value ith (S54). The variable i at the time when an affirmative determination is made in the process in S52 corresponds to a predicted time until the threshold value αth reaches the maximum steered angle θtmax. The threshold value ith is set according to a lower limit value at which it is determined that there is a high risk that a jackknife occurs. Then, when it is determined that the variable i is equal to or more than the threshold value ith (S54: YES), the PU 52 executes the processes in S34 and S36. The process in S54 corresponds to a determination process.

In the process in S34, the PU 52 changes the blinking cycle according to the value of the variable i. Here, the PU 52 sets the cycle at the time when the value of the variable i is small to be equal to or less than the cycle at the time when the value of the variable i is large.

The PU 52 temporarily ends the series of processes illustrated in FIG. 8 when making a negative determination in the processes in S10 and S54 and when completing the process in S36.

### Fourth Embodiment

A fourth embodiment will be described below with reference to the drawings, focusing on the differences from the first embodiment.

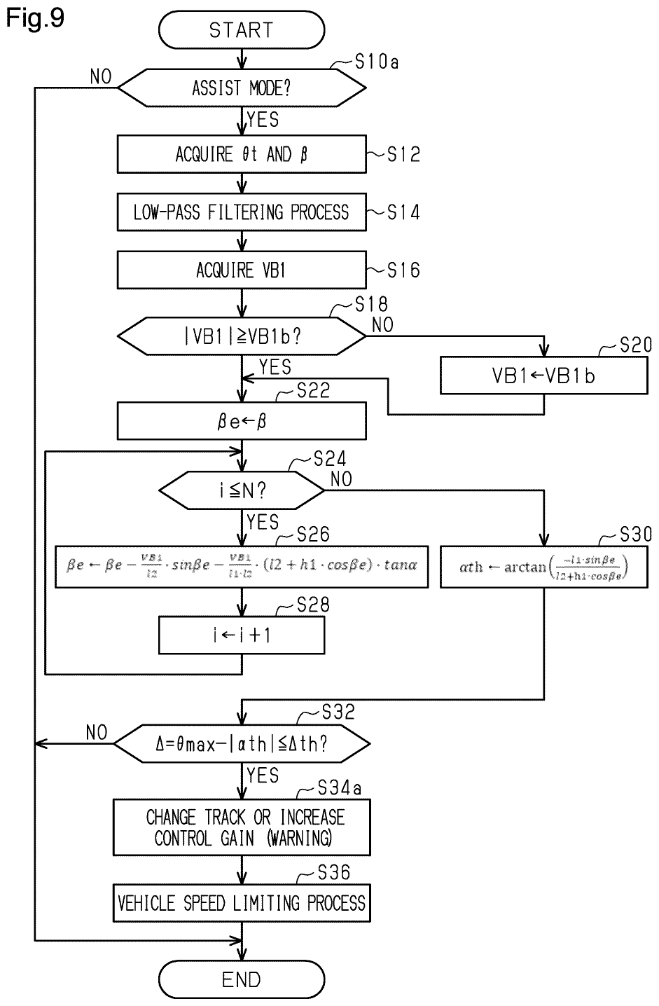

In the present embodiment, when executing reverse travel control by autonomous driving of the combined vehicle 10, a process is executed to suppress the occurrence of a jackknife. FIG. 9 illustrates the procedure of a process of suppressing a jackknife according to the present embodiment. The process illustrated in FIG. 9 is implemented by the PU 52 executing the jackknife suppression program 54a repeatedly in predetermined cycles, for example. In FIG. 9, the same step numbers are given to processes corresponding to the processes illustrated in FIG. 3 for convenience, and the description thereof will be omitted.

In the series of processes illustrated in FIG. 9, the PU 52 first determines whether the vehicle is in an assist mode (S10a). Then, when it is determined that the vehicle is in the assist mode (S10a: YES), the PU 52 executes the processes in S12 to S32.

Then, when it is determined that the amount Δ is equal to or less than the prescribed value Δth (S32: YES), the PU 52 executes a process of reducing the risk that a jackknife occurs (S34a). Here, the PU 52 changes the travel track of the combined vehicle 10 so as to reduce the curvature of the travel track. This is a setting to facilitate controlling the steered angle θt such that a jackknife will not occur. When it is determined that it is difficult to change the curvature, however, the PU 52 increases the control gain. Here, the control gain may be a gain for feedback controlling the steered angle θt to a target steered angle. Alternatively, the control gain may be a gain for feedback controlling the travel track to a target travel track. In this event, the PU 52 may execute a warning process by operating the display device 82 in order to inform the user that the risk that a jackknife occurs has increased and that the process has been switched to treat the risk. However, it is desirable that the PU 52 should not issue a warning when a travel track with a relatively high risk of occurrence of a jackknife is intentionally set, for example. Even when a warning is to be issued, a warning may be issued only when there is a higher risk than during manual driving. Among the processes in S34a, the process of reducing the curvature corresponds to a track change process. The process of increasing the control gain in S34a corresponds to a gain increase process. The process of issuing a warning corresponds to an informing process.

Then, the PU 52 proceeds to the process in S36. The PU 52 temporarily ends the series of processes illustrated in FIG. 9 when completing the process in S36 and when making a negative determination in the processes in S10a and S32.

### Other Embodiments

The present embodiment can be modified and carried out as follows. The present embodiment and the following modifications can be combined and carried out insofar as no technical contradiction arises.

### “Acquisition Process”

While the steered angle θt detected by the steering angle sensor 70 is acquired as the steered angle variable in the process in S12, the present invention is not limited thereto. For example, a yaw rate detected by a yaw rate sensor and a vehicle speed may be acquired. That is, a set of a detected value from the yaw rate sensor and a vehicle speed may be acquired as the steered angle variable. Further, a difference between the respective speeds of the right and left wheels or a set of the respective speeds of the right and left wheels, for example, may be acquired as the steered angle variable.
While the hitch angle β detected by the hitch angle sensor 74 is used as the initial value of the hitch angle β in the process in S26, the present invention is not limited thereto. For example, an estimated value may be used. This is achieved by regarding the hitch angle with the vehicle traveling straight as zero and estimating the hitch angle β each time through a process that is similar to the process in S26, for example. In other words, the value of the hitch angle variable acquired through the acquisition process is not limited to a detected value.

### “Prediction Process”

While a predicted hitch angle βe is calculated using the present rear wheel vehicle speed VB1 in the process in S26 in FIGS. 3 and 9, the present invention is not limited thereto. For example, a vehicle speed determined in advance may be used. Further, a predicted hitch angle βe may be calculated using a vehicle speed determined in advance in place of the present rear wheel vehicle speed VB1 in the process in S26 in FIG. 8, for example. That is, the present rear wheel vehicle speed VB1 is not essential as an input for the prediction process.
   While Nis an integer of “1” or more in the processes in FIGS. 3 and 9, N is not limited thereto, and may be “0”. In that case, it is desirable that the unit time in the process in S26 should be set to a large value.
   The process of calculating a predicted hitch angle βe is not limited to the process based on the model illustrated in FIG. 4. For example, a regression model may be used as a learned model that receives the value of the steered angle variable and the value of the hitch angle variable as inputs and that outputs the value of the predicted hitch angle βe. Here, a linear regression model or a neural network model can be used as the regression model.

### “Informing Process”

While the blinking cycle of the object displayed on the display device 82 is changed according to the magnitude of the risk that a jackknife occurs in the above embodiment, the present invention is not limited thereto.
   While it is indicated that there is a high risk of a jackknife through blinking of the object displayed on the display device 82 in the above embodiment, the present invention is not limited thereto. For example, it may be indicated that there is a high risk of a jackknife using a warning sound. In this event, at least one of the type of the warning sound and the cycle of producing the warning sound may be changed according to the magnitude of the risk that a jackknife occurs.
   The process of indicating that there is a high risk that a jackknife occurs is not limited to a process of outputting at least one of a visual signal and an audio signal. For example, the process may be a process of increasing the reaction force of the steering wheel. Alternatively, the process may be a process of applying vibration to the steering wheel, for example.

### “Gain Increase Process”

While the gain is increased when it is determined that it is difficult to change the track in the above embodiment, the present invention is not limited thereto. For example, the process of increasing the gain may be executed at all times when an affirmative determination is made in the process in S32. In this event, the process of changing the track may not be included, or may be included.

### “Treatment Process”

While the vehicle speed is limited to a constant vehicle speed determined in advance or less in the process in S36, the present invention is not limited thereto. For example, the vehicle speed as the upper limit value may be changed according to the amount Δ by which the maximum steered angle θtmax exceeds the absolute value of the threshold value αth. In that case, the upper limit value at the time when the amount Δ is large is set to be equal to or more than the upper limit value at the time when the amount Δ is small.
   When an affirmative determination is made in the process in S32, the vehicle may be stopped by operating the driving system 62 and the braking system 64.

### “Control Device”

The control device is not limited to one that includes the PU 52 and the storage device 54 and that executes software processing. For example, the control device may include a dedicated hardware circuit, such as an ASIC, for example, that processes at least part of the software processing performed in the above embodiments through hardware processing. That is, the control device may include a processing circuit that includes any of the following configurations (a) to (c).
(a) A processing circuit including: a processing device that executes all of the above processes according to a program; and a program storage device such as a storage device that stores the program.
(b) A processing circuit including: a processing device that executes part of the above processes according to a program; a program storage device; and a dedicated hardware circuit that executes the rest of the processes.
(c) A processing circuit including a dedicated hardware circuit that executes all of the above processes.

Here, there may be a plurality of software execution devices including a processing device and a program storage device, and a plurality of dedicated hardware circuits.

### “Vehicle”

The combined vehicle is not limited to the vehicle illustrated in FIG. 1. The vehicle is not limited to a combined vehicle.

### “Others”

While the present disclosure has been described based on the embodiments, it is understood that the present disclosure is not limited to such embodiments or structures. The present disclosure also includes various alterations and modifications that fall within the scope of equivalence. In addition, various combinations and configurations, as well as other combinations and configurations that include only one element or more or fewer elements, fall within the scope of or the scope of concept of the present disclosure.

The language “at least one of A and B” as used herein should be understood to mean “only A, only B, or both A and B”.

1. A jackknife suppression device that is applicable to a combined vehicle including a tractor and a trailer to be towed by the tractor, wherein:
the jackknife suppression device is configured to execute an acquisition process, a prediction process, a determination process, and a treatment process;
the acquisition process is a process of acquiring a hitch angle variable and a steered angle variable, the hitch angle variable being a variable that indicates a hitch angle that is an angle between a front-rear direction of the tractor and a front-rear direction of the trailer, and the steered angle variable being a variable that indicates a steered angle of the tractor;
the prediction process is a process of calculating a predicted value of the hitch angle using the hitch angle variable and the steered angle variable as inputs;
the determination process is a process of determining whether there is a high risk that a jackknife occurs using the predicted value and the steered angle variable as inputs; and
the treatment process is a process of operating predetermined hardware in order to suppress occurrence of the jackknife when it is determined that the risk is high.

2. The jackknife suppression device according to claim 1, wherein the acquisition process includes a process of acquiring a detected value from a sensor that detects the hitch angle as the hitch angle variable.

3. The jackknife suppression device according to claim 2, wherein the prediction process includes executing a process of calculating a future hitch angle using the detected value as an input, thereafter executing a process of calculating a further future hitch angle using the calculated future hitch angle as an input at least once, and setting a finally calculated future hitch angle to the predicted value.

4. The jackknife suppression device according to claim 1, wherein:
the acquisition process includes a process of acquiring a vehicle speed; and
the prediction process includes a process of calculating the predicted value at a time when the combined vehicle travels at the acquired vehicle speed for a predetermined period when the vehicle speed is equal to or more than a reference value, and calculating the predicted value at a time when the combined vehicle travels at a vehicle speed greater than zero assumed in advance for the predetermined period when the vehicle speed is not equal to or more than the reference value.

5. The jackknife suppression device according to claim 1, wherein the determination process includes:
a threshold value setting process of setting a threshold value that is a value of the steered angle variable at which the jackknife occurs using the predicted value as an input; and
a risk determination process of determining that the risk is high when an amount by which a maximum possible value of the steered angle variable exceeds the threshold value is equal to or less than a prescribed value.

6. The jackknife suppression device according to claim 3, wherein:
the prediction process includes a threshold value setting process of setting a threshold value that is a value of the steered angle variable at which the jackknife occurs using the predicted value as an input, and includes a process of continuing calculation of the predicted value until the threshold value reaches a predetermined value; and
the determination process includes a risk determination process of determining that the risk is high when a predicted time before the threshold value reaches the predetermined value is equal to or less than a predetermined time.

7. The jackknife suppression device according to claim 1, wherein the jackknife suppression device is configured to execute:
a reception process of receiving an intention of a user about a criterion for determining that the risk is high; and
a setting process of setting the criterion according to the intention received in the reception process.

8. The jackknife suppression device according to claim 1, wherein the treatment process includes an informing process of informing a user of the combined vehicle that the risk is high.

9. The jackknife suppression device according to claim 1, wherein:
the jackknife suppression device is configured to execute an automatic steering process of automatically operating a steered angle of the trailer; and
the treatment process includes a gain increase process of increasing a gain of the automatic steering process.

10. The jackknife suppression device according to claim 1, wherein:
the jackknife suppression device is configured to execute an automatic steering process of automatically operating a steered angle of the trailer; and
the treatment process includes a track change process of changing a travel track of the combined vehicle during the automatic steering process.

11. The jackknife suppression device according to claim 1, wherein the treatment process includes a process of limiting a vehicle speed to a lower side.

12. A jackknife suppression method, the method being applicable to a combined vehicle including a tractor and a trailer to be towed by the tractor, and the method comprising:
acquiring a hitch angle variable and a steered angle variable, the hitch angle variable being a variable that indicates a hitch angle that is an angle between a front-rear direction of the tractor and a front-rear direction of the trailer, and the steered angle variable being a variable that indicates a steered angle of the tractor;
calculating a predicted value of the hitch angle using the hitch angle variable and the steered angle variable as inputs;
determining whether there is a high risk that a jackknife occurs using the predicted value and the steered angle variable as inputs; and
operating predetermined hardware in order to suppress occurrence of the jackknife when it is determined that the risk is high.

13. A non-transitory computer-readable medium storing a jackknife suppression program, the program being applicable to a combined vehicle including a tractor and a trailer to be towed by the tractor, and the program causing a computer to execute an acquisition process, a prediction process, a determination process, and a treatment process, wherein:
the acquisition process is a process of acquiring a hitch angle variable and a steered angle variable, the hitch angle variable being a variable that indicates a hitch angle that is an angle between a front-rear direction of the tractor and a front-rear direction of the trailer, and the steered angle variable being a variable that indicates a steered angle of the tractor;
the prediction process is a process of calculating a predicted value of the hitch angle using the hitch angle variable and the steered angle variable as inputs;
the determination process is a process of determining whether there is a high risk that a jackknife occurs using the predicted value and the steered angle variable as inputs; and
the treatment process is a process of operating predetermined hardware in order to suppress occurrence of the jackknife when it is determined that the risk is high.
